(19) United States
(12) Patent Application Publication
(10) Pub. No.: US 2014/0153508 A1
(43) Pub. Date: Jun. 5, 2014

(54) METHOD OF COORDINATED MULTI-POINT TRANSMISSION AND RECEPTION

(71) Applicant: POSTECH ACADEMY - INDUSTRY FOUNDATION, Gyeongbuk (KR)

(72) Inventors: Dong Hyun Lee, Seoul (KR); Jong Kim, Gyeongsangbuk-do (KR); Won Jin Sung, Seoul (KR)

(73) Assignee: POSTECH ACADEMY - INDUSTRY FOUNDATION, Gyeongbuk (KR)

(21) Appl. No.: 14/091,206

(22) Filed: Nov. 26, 2013

(30) Foreign Application Priority Data
Dec. 4, 2012 (KR) 10-2012-0139598

(51) Int. Cl. H04L 5/00

(52) U.S. Cl. CPC H04L 5/0035
USPC 370/329

(57) ABSTRACT

Disclosed is a coordinated multi-point (CoMP) transmission and reception method. A method of determining a CoMP set in an apparatus for determining a CoMP set of a CoMP system includes transmitting reference signal information from each point, collecting preferred point set information corresponding to the reference signal information, determining the CoMP set based on the collected preferred point set information, and determining transmission target terminals for each component carrier based on the determined CoMP set. The transmission method using the CoMP set may improve performance of a system and enhance frequency efficiency.

### CLAIM FOR PRIORITY

This application claims priority to Korean Patent Application No. 10-2012-0139598 filed on Dec. 4, 2012 in the Korean Intellectual Property Office (KIPO), the entire contents of which are hereby incorporated by reference.

### BACKGROUND OF INVENTION

1. Technical Field

Example embodiments of the present invention relate in general to a coordinated multi-point (CoMP) transmission and reception system, and more specifically, to a CoMP system in an environment where there is a plurality of component carriers.

2. Related Art

If a density of users in a specific area such as a complex facility or a shopping mall in a cellular mobile communication system increases, a quality of service provided to the users in the area decreases rapidly. In this case, communications service providers may additionally install small points in the area in order to improve the quality of service. The installation of the small points helps to increase performance by generating new cell coverage, but causes an increase of interference from neighboring points as the number of small points increases. Interference among the small points deteriorates the performance of the entire system, and therefore transmission efficiency is improved through CoMP transmission and reception among the small points.

CoMP transmission and reception is a transmission scheme in which a plurality of points configure one CoMP set and cooperatively transmit and receive data. The points included in the CoMP set may control the interference from neighboring points by sharing a series of information required for a transmission. In a cellular system that shares the same frequency, the increase of points causes a problem of interference among neighboring cells and decreases performance of the entire system. Under such circumstances, the CoMP transmission and reception is a technique that can effectively control interference and increase frequency efficiency in a system.

Further, carrier aggregation refers to a technique that uses two or more component carriers together for a signal transmission. Advancement from Long Term Evolution (LTE) to Long Term Evolution-Advanced (LTE-Advanced) increases the requirement for a maximum transmission bandwidth to be used for signal transmission from 20 MHz to 100 MHz. However, since it was difficult to allocate continuous frequency bandwidths of 100 MHz, carrier aggregation, a scheme for aggregating and using frequencies in different bandwidths, has been attracting attention. Since a bandwidth of one component carrier is 20 MHz, up to five component carriers may be combined for a signal transmission, and it is possible to use two schemes: intra-band aggregation for combining and using component carriers in neighboring frequency bandwidths, and inter-band aggregation for combining and using component carriers in different frequency bandwidths. The carrier aggregation technique supports different frequency bandwidths owned by communications service providers so that they can be applied in one system, and consequently this may improve performance of the entire system.

However, a method of increasing frequency efficiency by the CoMP transmission and reception in a single component carrier does not consider other available component carriers, so an increase in system performance and a frequency efficiency in a multiple component carrier system is limited.

### SUMMARY

Example embodiments of the present invention provide a method of determining coordinated multi-point (CoMP) sets including carrier aggregations in a system using multiple component carriers, which is a CoMP transmission and reception method for increasing performance of a system and frequency efficiency.

In some example embodiments, a coordinated multi-point (CoMP) transmission and reception method comprises transmitting reference signal information from each point, collecting preferred point set information corresponding to the reference signal information, determining a CoMP set based on the collected preferred point set information, and determining transmission target terminals for each component carrier based on the determined CoMP set.

Here, the reference signal information may include information on a point configured to transmit the reference signal information and information on component carriers.

Here, the collecting of the preferred point set information may comprise collecting from the point received the preferred point set information by the apparatus for determining a CoMP set.

Here, the determining of the CoMP set may comprise allocating weights to all CoMP sets having preferred points in the one of collected preferred point set information, as a normalized set so that the weights total to 1, performing the allocating of the weights for all collected preferred point set information, and selecting a CoMP set with a maximum weight among available CoMP sets.

Here, the determining of the transmission target terminals for each component carrier based on the determined CoMP set may comprise determining terminals so that a sum of the weights in the determined CoMP set for a primary component carrier configured to support an entire cell is maximized, and determining terminals so that a sum of the weights in the determined CoMP set for component carriers except the primary component carrier is maximized.

Here, the CoMP method may further comprise transmitting signals using carrier aggregations to terminals which are transmission targets of at least two component carriers among the determined terminals.

Here, the determining of the transmission target terminals for each component carrier based on the determined CoMP set includes determining terminals so that a sum of the weights in the determined CoMP set for the primary component carrier configured to support an entire cell is maximized, and determining terminals except terminals configured to receive transmissions from previous component carriers among terminals of the determined CoMP set for component carriers except the primary component carrier so that a sum of the weights is maximized.

In other example embodiments, a CoMP method performed in a terminal in a CoMP system may comprise receiving reference signal information from at least one point, generating preferred point set information based on the received reference signal information, and transmitting the generated preferred point set information.

Here, the preferred point set information may include preferred point information and preferred component carrier information.

Here, the preferred point information and the preferred component carrier information may be determined based on received power for each component carrier of a point corresponding to the received reference signal information and a predetermined standard value.

Here, the predetermined standard value is a value of maximum received power having a margin of a predetermined value.

Here, the predetermined standard value is an average value of received power.

According to the CoMP method described above, that is, a transmission method of a wireless transmission system to which both the CoMP transmission and reception and the carrier aggregation are applied, requirements of multiple users are satisfied and limited frequency resources can be efficiently used by configuring a CoMP set so that the best efficiency is provided at every moment in a cellular system where one system is configured with a plurality of points, and by performing the coordinated multi-point transmission and reception.

### BRIEF DESCRIPTION OF DRAWINGS

The above and other objects, features and advantages of the present invention will become more apparent by describing in detail example embodiments of the present invention with reference to the accompanying drawings, in which:

FIG. 1 is a concept diagram illustrating a system for describing a coordinated multi-point (CoMP) transmission and reception method according to an embodiment of the present invention.

FIG. 2 is a diagram illustrating kinds of CoMP sets and the number of configurable combinations of each set in the CoMP method according to an embodiment of the present invention.

FIG. 3 is a diagram illustrating an example of a method of determining a CoMP set in a CoMP method according to an embodiment of the present invention.

FIG. 4 is a diagram illustrating a method of allocating weights to CoMP sets in a CoMP method according to an embodiment of the present invention.

FIG. 5 is a diagram illustrating a system using a plurality of component carriers in a CoMP method according to an embodiment of the present invention.

FIG. 6 is a flowchart illustrating operation of an apparatus for determining a CoMP set in a CoMP method according an embodiment of the present invention.

FIG. 7 is a flowchart illustrating operation of a terminal in a CoMP method according to an embodiment of the present invention.

### DETAILED OF EXAMPLE EMBODIMENTS

While the invention is susceptible to various modifications and alternative forms, specific embodiments thereof are shown by way of example in the drawings and will herein be described in detail.

It should be understood, however, that there is no intent to limit the invention to the particular forms disclosed. On the contrary, the invention is to cover all modifications, equivalents, and alternatives falling within the spirit and scope of the inventive concept and technology.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, and/or components, but do not preclude the presence or addition of one or more other features, numbers, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

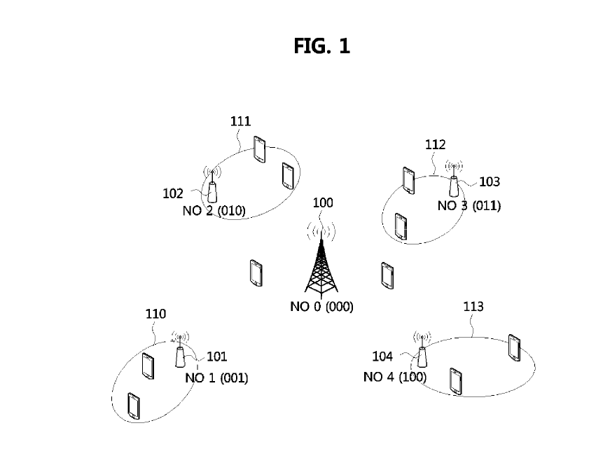

FIG. 1 is a concept diagram illustrating a system for describing a coordinated multi-point (CoMP) transmission and reception method according to an example embodiment of the present invention. FIG. 1 illustrates an example of a model in which a plurality of points form one cellular mobile communication system. The system of FIG. 1 has one central point 100 that controls the entire system and four small points 101, 102, 103, and 104 near the central point 100. The plurality of considered points configures one cellular mobile communication system, and this model in particular has one central point that controls the entire system and small points nearby. In the system, virtual point numbers are assigned in order that terminals can differentiate the points, and numbers from 0 to 4 are assigned to the points, with number 0 assigned to the central point 100, as illustrated in FIG. 1.

A CoMP system includes an apparatus for determining a CoMP set that determines CoMP set, and the apparatus for determining a CoMP set exists in an entity such as Mobility Management Entity (MME) of a point or a core network.

The apparatus for determining a CoMP set periodically transmits reference signal information on all points including small points existing in the system using a downlink of a corresponding point, and the corresponding reference signal information includes virtual numbers of the points that differentiate the points and information on the number of component carriers that the corresponding point currently uses. The specific reference signal information may be defined as in Equation 1 below.

Sᵣ=[n₁, . . . , n_{M}, c₁, . . . , c_{N}] [Equation 1]

In Equation 1, nᵢ is a virtual number of a point with a binary vector.

Considering circumstances of 7 points, M is 3, and cᵢ indicates the number of additional component carriers with binary vectors. For example, LTE-Advanced supports a maximum of 5 component carriers, so the existence of a maximum of 4 additional component carriers by assignment of 3 bits may be transmitted, so N may be 3. Therefore, reference signal information of the third point having two carrier waves in an environment of 7 points may include [01110].

When each point generates and transmits reference signal information including such structure, a terminal recognizes the number of component carriers and points by receiving the corresponding signal information. Further, information on power received from the corresponding point is stored. The power received from points existing in the system may be defined as in Equation 2 below.

P₁(i,j)=1/KΣ↓k↑K [symbol] ∥□h↓(i,j) ∥□↑2□ [Equation 2]

P_{i,j} is average received power between the i-th point and the j-th terminal, and h_{i,j} is a channel gain between the i-th point and the j-th terminal. K is the number of receiving antenna of a terminal, and the average received power may be obtained by dividing the sum of the power received from each antenna by the number of receiving antenna.

The terminal compares power received from points that can be received in the system with a specific standard value to determine points having received power higher than the standard value, and the determined points may be a preferred point set for CoMP of a corresponding terminal. An operation of measuring power received from points and an operation of determining preferred points are independently performed. The standard value in an operation of determining a point set preferred by terminals may use an absolute value and a relative value as follows. The absolute value may be set to a specific power value previously determined in the system, and the absolute value may be determined through power received from points.

Standard received power Pₜₕ of the terminal j may be defined as in Equation 3 or Equation 4. Here, I is the number of points.

Pₜₕ=MAX└P_{i,j}, . . . ,P_{i,j}┘−P_{A}Pₜₕ=MAX[P_{i,j}, . . . ,P_{i,j}]−P_{A} [Equation 3]

The standard received power Pₜₕ may be defined as a value of the maximum received power with a margin of P_{A}[dB] among power of points received by a terminal, as in Equation 3.

$${P}_{th} = \frac{1}{I} {\sum }_{i}^{l} {P}_{i , j} \qquad [ Equation 4 ]$$

Alternately, the standard received power Pₜₕ may be defined as an average of power received from points, as in Equation 4.

The terminal may generate information on the preferred point set and virtual numbers of points with maximum received power as binary vectors, and transmit the information and the virtual numbers to the apparatus for determining a CoMP set using an uplink channel.

X=[x₁, 1, . . . ,x_{A1}, . . . ,x_{I,C}, . . . ,x_{I,c}] [Equation 5]

Equation 5 defines a structure for the preferred point set information transmitted by the terminal to the system. x_{I,C} denotes preference for the i-th point using the c-th component carrier as 1 or 0, I is the number of the points existing in the system, and C is the number of the component carriers currently used by the system. The terminal assigns 1 if the power received from the corresponding point is larger than the standard value, and assigns 0 if the power is smaller than the standard value. For example, in a system environment that has 5 points and uses 5 component carriers, if the terminal prefers the fourth component carrier of the first point, the second component carrier of the second point, and the second and fourth component carriers of the third point, the preferred point set information may include [00010 01000 01010 00000 00000].

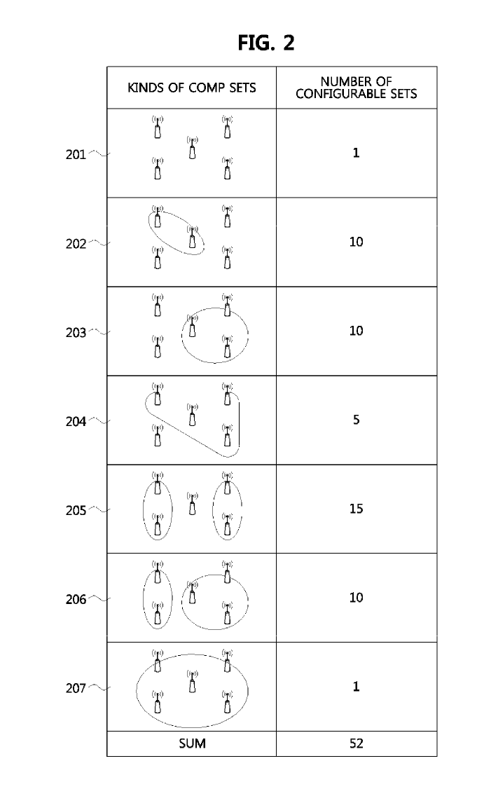

FIG. 2 is a diagram illustrating kinds of CoMP sets that can be used in a system that has 5 points, and the number of configurable combinations of each set in the CoMP method according to an example embodiment of the present invention.

In the system that has 5 points, there are 52 CoMP sets CoMP1 to CoMP52 in total. In particular, the number of CoMP sets for each kind of CoMP set is 1 if all points separately perform transmission without CoMP as indicated by reference numeral 201, 10 if two points form one CoMP set and the other three points separately perform transmission as indicated by reference numeral 202, 10 if three points form one CoMP set and the other two points separately perform transmission as indicated by reference numeral 203, 5 if four points form one CoMP set and the other one point separately performs transmission as indicated by reference numeral 204, 15 if two CoMP sets are formed with two points each, and the other one point separately performs transmission as indicated by reference numeral 205, 10 if two points form one CoMP set and the other three points form another CoMP set as indicated by reference numeral 206, and 1 if the five points form one CoMP set as indicated by reference numeral 207. A plurality of CoMP sets may be configured in the system, as illustrated in FIG. 2.

The apparatus for determining a CoMP set allocates weights to all CoMP sets including the corresponding points of the preferred point set information based on the preferred point set information received from each terminal.

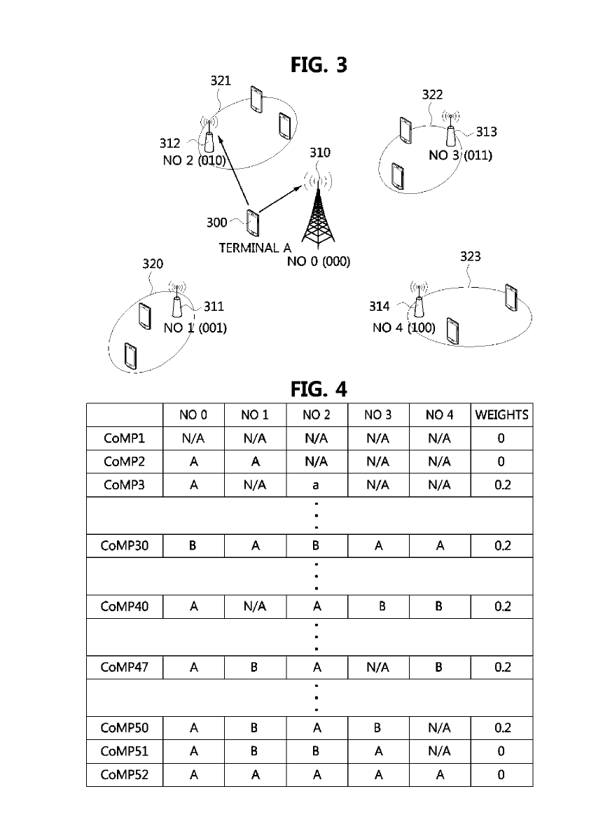

FIG. 3 is a diagram illustrating an example of a method of determining a

CoMP set in a CoMP method according to an example embodiment of the present invention.

For example, according to the method of determining a CoMP set in a system having one component carrier, a terminal A 300 in a system in which a point 310 with a virtual point number 0 and a point 312 with a virtual point number 2 have received power higher than the standard received power Pₜₕ reports to the apparatus for determining a CoMP set that the points with virtual point numbers 0 and 2 are preferred, using the preferred point set information.

FIG. 4 is a diagram illustrating a method of allocating weights to CoMP sets in a CoMP method according to an example embodiment of the present invention.

The apparatus for determining a CoMP set collecting preferred point set information from the terminal A 300 allocates weights to all CoMP sets having the points with numbers 0 and 2 in one set. The total sum of the weights is defined as 1, and 1 is equally distributed depending on the number of CoMP sets that can be used.

As illustrated in FIG. 4, the CoMP sets CoMP3, CoMP30, CoMP40, CoMP47, and CoMP50 have the points with the numbers 0 and 2 in one CoMP set. That is, the weights of 0.2 are evenly assigned to the five CoMP sets.

In order to determine the CoMP set, the apparatus for determining a CoMP set performs the weight allocating operation for all terminals and calculates the sum of the weights of the COP sets that can be used.

The terminal selects an set having the highest weight among the CoMP sets that can be used. If the CoMP set is determined according to the operation, a signal may be transmitted using the same set until a next CoMP set is determined.

If the CoMP set to be used for the signal transmission is determined, the apparatus for determining a CoMP set determines the terminal to which a signal is transmitted for each CoMP set.

For example, if the CoMP set CoMP50 is determined as the CoMP set, points with the numbers 0 and 2 form one CoMP set, points with the numbers 1 and 3 form another CoMP set, and a point with the number 4 separately performs transmission, as illustrated in FIG. 4.

Therefore, terminals indicating maximum received power from the points with the numbers 0 and 2 become terminals for the corresponding CoMP set, and terminals indicating maximum received power from the points with the numbers 1 and 3 become terminals for the corresponding CoMP set. In addition, a terminal indicating maximum received power from the point with the number 4 becomes a terminal for the separate transmission.

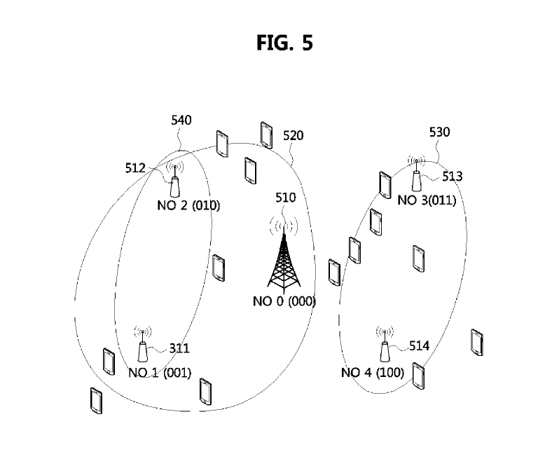

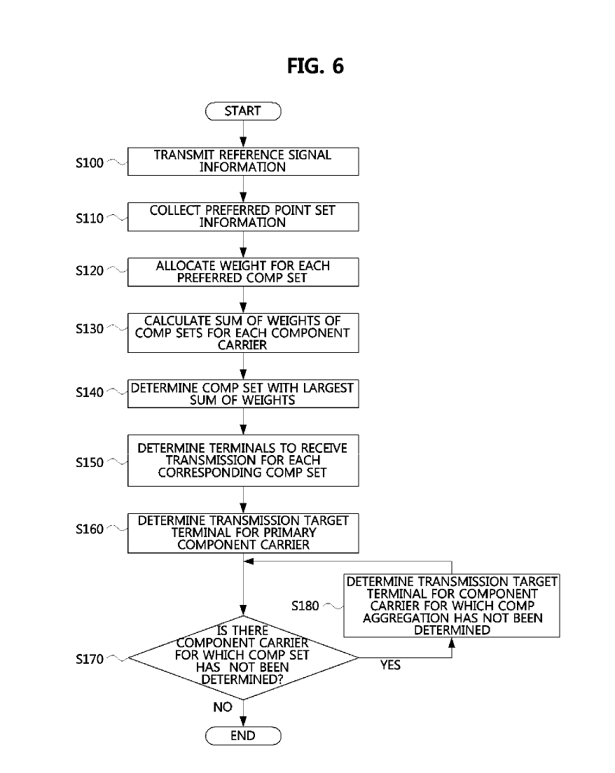

FIG. 5 is a diagram illustrating a system using a plurality of component carriers in a CoMP method according to an example embodiment of the present invention.

A cellular mobile communication system that uses a plurality of component carriers has a component carrier that supports the entire cell among the component carriers. In general, a component carrier with the lowest frequency bandwidth or with the largest bandwidth plays the role, and the component carrier is referred to as a primary component carrier. According to the present invention, the component carrier with the lowest frequency bandwidth or with the largest bandwidth is not specified.

If a CoMP set and terminals to be used for each component carrier are determined as described above, terminals to receive a signal in a corresponding sub-frame for each component carrier are determined. A method of maximizing the performance of the entire system by using a plurality of component carriers is as follows.

First, the apparatus for determining a CoMP set determines a terminal to receive a signal for a primary component carrier that supports the entire cell. After the CoMP is determined, when a terminal to receive a signal by using the corresponding CoMP is selected, the weighted sum-rate is set to be maximized. In addition, the terminals determined in this operation store information such as index information of the terminals and previous transmission rates of corresponding terminals.

Two methods may be used for determining terminals to receive signals for component carriers other than the primary component carrier.

One method is selecting terminals that have the maximum weighted sum-rates in a CoMP set determined for a corresponding component carrier. In addition, the terminals determined in the present operation store information such as the index information of the terminals or previous transmission rates of the corresponding terminals.

According to the method described above, the terminals to receive signals from a plurality of component carriers are generated and the carrier aggregation can be used.

Another method is selecting terminals except terminals selected for previous component carriers including the primary component carrier among terminals of the CoMP set determined for the corresponding component carrier so that the weighted sum-rates are maximized.

One of the two methods described above may be selectively used as a method of selecting terminals for component carriers except the primary component carrier, and both of the methods may be used in combination depending on the situation.

FIG. 5 is a diagram illustrating an example in which two component carriers determined according to the methods described above have different cell border areas. A component carrier #1 has one CoMP set 520 configured with a point 510 with the number 0, a point 511 with the number 1, and a point 512 with the number 2, and another CoMP set 530 with a point 513 with the number 3 and a point 514 with the number 4. A component carrier #2 has the point 510 with the number 0, the point 513 with the number 3, and the point 514 with the number 4 that do not participate in the CoMP, and one CoMP set 540 configured with the point 511 with the number 1 and the point 512 with the number 2.

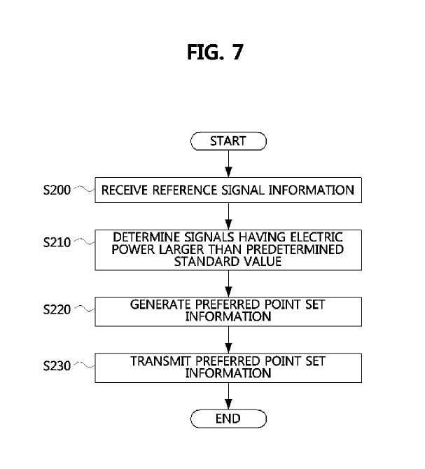

FIG. 6 is a flowchart illustrating operation of an apparatus for determining a CoMP set in a CoMP method according an example embodiment of the present invention.

The apparatus for determining a CoMP set transmits reference signal information of a corresponding point through each point in step 100. The reference signal information includes a number of a corresponding point and a number of component carriers that are used by the corresponding point.

The terminals that receive the reference signal information evaluate received power for each carrier wave of the point corresponding to the reference signal information, generate preferred point set information from the component carrier information of the point having power larger than a predetermined standard value, and transmit the preferred point set information to the point, and the apparatus for determining a CoMP set collects the preferred point set information from the transmitted point in step 110.

The apparatus for determining a CoMP set distinguishes preferred CoMP sets from the preferred point set information collected from the terminal, and allocates weights to each CoMP set in step 120.

The apparatus for determining a CoMP set calculates the sum of the weights of the CoMP sets for each component carrier based on weights allocated in the previous step 120 from the preferred point set information collected from all terminals in the system in step 130.

The apparatus for determining a CoMP set determines the CoMP set with the largest sum of weights among the sums of the weights of the CoMP sets for the component carriers in step 140, and determines the terminals included in the corresponding CoMP set together in step 150.

The apparatus for determining a CoMP set determines a terminal of the determined CoMP set with the largest sum of weights corresponding to the primary component carrier that covers the entire cell as the terminal to which the transmission is performed in step 160.

The apparatus for determining a CoMP set determines whether there is a component carrier for which the CoMP set is not determined in step 170, and determines a transmission target terminal for a component carrier for which the CoMP set is not determined in step 180.

A method of determining terminals to receive transmissions from component carriers except the primary component carrier may include determining terminals so that the sum of the weights is maximized in the CoMP set determined for the corresponding carrier, and determining terminals except terminals that receive transmissions from other component carriers among terminals of the CoMP set determined for the corresponding component carrier.

FIG. 7 is a flowchart illustrating operation of a terminal in a CoMP method according to an example embodiment of the present invention.

The terminal in the CoMP system receives reference signal information from a point in step 200. The reference signal information includes a number of the point and a number of component carriers used by the point.

The terminals that receive reference signal information from the point determine component carriers of points having power larger than a predetermined standard value by evaluating received power for each carrier wave of each point corresponding to the reference signal information in step 210. The standard value may be an absolute value or a relative value, and the value may be determined by Equation 3 or 4 above.

The terminals in the CoMP system use the result determined in the step 210 to generate preferred point set information including the structure of Equation 5 in step 220.

The terminals in the CoMP system transmit the preferred point set information through the point to the apparatus for determining a CoMP set in step 230.

While example embodiments of the present invention have been described in detail, those skilled in the art will understand that various changes may be made to the example embodiments without departing from the scope of the invention as defined by the appended claims.

What is claimed is:

1. A method of determining a coordinated multi-point (CoMP) set in an apparatus for determining a CoMP set of a CoMP system, comprising:
transmitting reference signal information from each point;
collecting preferred point set information corresponding to the reference signal information;
determining the CoMP set based on the collected preferred point set information; and
determining transmission target terminals for each component carrier based on the determined CoMP set.

2. The method of claim 1, wherein the reference signal information includes information on a point configured to transmit the reference signal information and information on component carriers.

3. The method of claim 1, wherein the collecting the preferred point set information comprises collecting from the point received the preferred point set information by the apparatus for determining a CoMP set.

4. The method of claim 1, wherein the determining of the CoMP set comprises:
allocating weights to all CoMP sets having preferred points in the one of collected preferred point set information, as a normalized set so that the weights total to 1;
performing the allocating of the weights for all collected preferred point set information; and
selecting a CoMP set with a maximum weight among available CoMP sets.

5. The method of claim 1, wherein the determining of the transmission target terminals for each component carrier based on the determined CoMP set comprises:
determining terminals so that a sum of the weights in the determined CoMP set for a primary component carrier configured to support an entire cell is maximized; and
determining terminals so that a sum of the weights in the determined CoMP set for component carriers except the primary component carrier is maximized.

6. The method of claim 5, further comprising:
transmitting signals using carrier aggregations to terminals which are transmission targets of at least two component carriers among the determined terminals.

7. The method of claim 1, wherein the determining of the transmission target terminals for each component carrier based on the determined CoMP set comprises:
determining terminals so that a sum of the weights in the determined CoMP set for the primary component carrier configured to support an entire cell is maximized; and
determining terminals except terminals configured to receive transmissions from previous component carriers among terminals of the determined CoMP set for component carriers except the primary component carrier so that a sum of the weights is maximized.

8. A CoMP method performed in a terminal in a CoMP system, comprising:
receiving reference signal information from at least one point;
generating preferred point set information based on the received reference signal information; and
transmitting the generated preferred point set information.

9. The CoMP method of claim 8, wherein the preferred point set information includes preferred point information and preferred component carrier information.

10. The CoMP method of claim 9, wherein the preferred point information and the preferred component carrier information are determined based on received power for each component carrier of a point corresponding to the received reference signal information and a predetermined standard value.

11. The CoMP method of claim 10, wherein the predetermined standard value is a value of maximum received power having a margin of a predetermined value.

12. The CoMP method of claim 10, wherein the predetermined standard value is an average value of received power.
